(19) United States
(12) Patent Application Publication
(10) Pub. No.: US 2005/0016563 A1
(43) Pub. Date: Jan. 27, 2005

(54) Continuous loop dental floss and methods of making and dispensing same

(76) Inventor: Steven Prins, San Luis Obispo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/875,840

(22) Filed: Jun. 24, 2004

Related U.S. Application Data
(60) Provisional application No. 60/489,458, filed on Jul. 21, 2003.

(51) Int. Cl. A61C 15/00

(52) U.S. Cl. 132/321

(57) ABSTRACT

Systems and methods are described for making and dispensing continuous loops of dental floss that are formed from a monofilament material, such as PTFE or ePTFE, that glides easily between teeth without fraying or breaking. The continuous loop formation allows a user to apply sufficient tension to a section of floss to allow for flossing between adjacent teeth, without need for a floss-holding device or for the user to secure the floss with multiple wrappings around one or more fingers, which may be awkward, uncomfortable, and may reduce circulation to the fingers. Methods are described for cutting a cylindrical sleeve formed from the monofilament floss material to form continuous loops that may be attached together as a string of continuous loops, may be attached together along one side, or may be detached into individual loops. Furthermore, the use of a dispenser for dispensing individual loops from a string of continuous loops is described.

### PRIORITY APPLICATION

This application claims priority benefit of U.S. Provisional Patent Application No. 60/489,458 filed Jul. 21, 2003, titled “INFINITY FLOSS,” which is incorporated herein by reference in its entirety.

### BACKGROUND OF THE INVENTION

1. Field of the Invention

The present invention relates to dental floss and, in particular, to dental floss formed in continuous loops of monofilament material.

2. Description of the Related Art

Dentists commonly stress the importance of regular dental flossing to the health and hygiene of teeth and gums, as well as to other, more far-reaching, health concerns. Many dentists recommend flossing at least once every twenty-four to thirty-six hours in order to disrupt formation of plaque between teeth.

To effectively use floss to clean between teeth, tension is applied to a length of floss, which is then slid between two adjacent teeth in order to remove food particles, plaque, and other debris from between the teeth. One commonly employed method for flossing includes cutting, breaking, or otherwise separating a length of floss for use during a flossing session. The method further includes wrapping a portion of a first end of the length of floss around one or more fingers of a first hand, and wrapping a portion of a second end of the length of floss around one or more fingers of a second hand. By applying tension to the floss, the floss may be pulled taut so that it may fit between two adjacent teeth and may be manipulated to dislodge and remove debris from between the teeth and gingival sulcus.

By progressively unwinding floss that is wrapped around the finger(s) of a first hand and winding more of the floss onto the finger(s) of a second hand, a new, unused portion of floss may be positioned for use in flossing.

Current hand-held methods of using floss are awkward and uncomfortable for many users, and, indeed, many children and adults stop or never begin flossing due at least in part to these inconveniences. Many people complain that wrapping floss with sufficient tautness for flossing cuts off circulation to the fingers, even causing the finger tips to temporarily become discolored. Some find that repositioning the floss by frequently winding and unwinding the floss around the fingers is a difficult manipulation to perform properly. Also, by nature of the method, floss at the ends of the segment is used for wrapping, but not flossing, and is thus wasted, especially when users break off excessive lengths of floss for winding around the fingers.

Flossing devices designed to secure a length of floss for cleaning between the teeth are typically disposable, and thus, again wasteful. Furthermore, whether used by hand or in a flossing device, conventional nylon floss frequently shreds, frays, or breaks between closely spaced teeth, sometimes even leaving portions of the floss stuck between the teeth and difficult to remove.

Attempts have been made to overcome the above-mentioned problems by forming floss into loops that can be held by hand for flossing. However, loops formed from multi-filament floss of nylon or other fiber material suffers from the same incidence of breakage and fraying as described above. Some floss loops have been made at least in part from an elastic material that makes it difficult for the user to produce a sufficient tautness in the floss to easily slide the floss between the teeth. Furthermore, loops of elastic material pose a risk of “snapping” against a user's lips and mouth as they are pulled in and out of teeth.

These disadvantages may cause enough inconvenience for some users that it discourages them from flossing altogether.

### SUMMARY OF THE INVENTION

Systems and methods are described for making and dispensing continuous loops of dental floss that are formed from a material, such as PTFE or ePTFE, that glides easily between teeth without fraying or breaking. In various embodiments, the material is a monofilament material that is identical throughout the loop rather than being formed of multiple fibers wound or woven together. The continuous loop formation allows a user to apply sufficient tension to a section of floss to allow for flossing between adjacent teeth, without need for a floss-holding device or for the user to secure the floss with multiple wrappings around one or more fingers, which may be awkward, uncomfortable, and may reduce circulation to the fingers. Methods are described for cutting a cylindrical sleeve formed from the monofilament floss material to form continuous loops that may be attached together as a chain of continuous loops, may be attached together along one side, or may be detached into individual loops. Furthermore, the use of a dispenser for dispensing individual loops from a string of continuous loops is described.

An embodiment of a method is described for forming a chain of detachably connected continuous dental floss loops. The method comprises the acts of: (a) forming a cylindrical sleeve of polytetrafluoroethylene (PTFE), and (b) making a first cut that begins at an originating point and ends at an ending point along a diametrical axis across the cylindrical sleeve without completely cutting through an entire circumference of the cylindrical sleeve, such that a first small section of the circumference along a first longitudinal strip remains uncut. The method further comprises the acts of: (c) making a second cut that begins at an originating point and ends at an ending point across the cylindrical sleeve adjacent and parallel to the first cut without completely cutting through an entire circumference of said cylindrical sleeve, such that a second small section of the circumference along a second longitudinal strip remains uncut, and wherein an originating point of said first cut is adjacent to an ending point of said second cut and an originating point of said second cut is adjacent to an ending point of said first cut. The method further comprises repeating steps (b) and (c) until a chain of detachably connected continuous dental floss loops of desired length is formed.

Additional embodiments of methods for cutting a cylindrical sleeve of expanded or non-expanded PTFE to form continuous loops of dental floss are also described. According to one embodiment of one method, individual loops are cut off from the cylindrical sleeve. According to one embodiment of another method, cuts are made around a circumference of the cylindrical sleeve, wherein the cuts leave a small portion of the circumference uncut, so that a user may break the small uncut portion and break a loop off of a connected set of loops.

An embodiment of a dispenser for dispensing continuous dental floss loops is disclosed. The dispenser comprises a bobbin with a chain of continuous monofilament dental floss loops wound around it. The dispenser further comprises a container that is configured to house said bobbin such that the bobbin is free to rotate about an axis, allowing a portion of the chain of continuous dental floss loops to unwind from the bobbin. The container further comprises a gripping mechanism configured to secure with friction, at a location near one end of one of the two continuous dental floss loops, said portion of the chain of continuous dental floss loops, the gripping mechanism securing the portion of the chain of continuous dental floss loops with sufficient strength to allow at least one continuous dental floss loop to be torn off of the chain when sufficient pressure is applied to the continuous loop. The container may further comprise a hole for allowing the portion of the chain of continuous dental floss loops that are unwound from the bobbin to pass through, thus guiding the portion of the chain to the gripping mechanism.

An embodiment of an unbroken, continuous loop of dental floss material is disclosed wherein the dental floss material is formed of identical material throughout the loop. An embodiment is described wherein the dental floss loop has an identical cross-section throughout the loop.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages taught or suggested herein.

### BRIEF DESCRIPTION OF THE DRAWINGS

Various other objects, features and attendant advantages will become fully appreciated as the same becomes better understood when considered in conjunction with the accompanying drawings. The drawings and the associated descriptions are provided to illustrate embodiments of the invention and not to limit the scope of the invention. Like reference characters designate the same or similar parts throughout the several views.

FIG. 1 is a diagram depicting a side view of one embodiment of a continuous dental floss loop.

FIG. 2 is a diagram depicting one embodiment of a method for cutting a sleeve of monofilament material, such as polytetrafluoroethylene (PTFE) or expanded PFTE (ePTFE), to create a chain of continuous dental floss loops.

FIG. 3 is a diagram depicting one embodiment of a bobbin reel wound with a chain of continuous dental floss loops ready for dispensing.

FIG. 4A is a diagram depicting a first embodiment of a dispenser for a chain of continuous dental floss loops.

FIG. 4B is a diagram depicting one embodiment of a method for separating a continuous dental floss loop from a dispenser.

FIG. 5 is a diagram depicting an embodiment of a second method for cutting a sleeve of monofilament material, such as PTFE or ePTFE, to create continuous dental floss loops, stacked for packaging or use.

FIG. 6 is a diagram depicting an embodiment of a third method for cutting a sleeve of material, such as PTFE or ePTFE, to create continuous dental floss loops.

FIG. 6A is a close-up view of a portion of FIG. 6, showing in greater detail cuts made for form the continuous dental floss loops.

### DETAILED DESCRIPTION OF THE PREFERRED EMBODIMENT

A continuous loop of dental floss made from a monofilament, such as a polytetrafluoroethylene (PTFE) fiber, and methods of making and dispensing the floss are disclosed. The loop of floss allows a user to hold a section of floss taut while flossing without need for wrapping the ends of the floss multiple times around one or more fingers or for using a device to hold the floss. As the user flosses with a section of the floss, the loop may be easily rotated so as to allow the user to position a new, unused portion of the loop for flossing.

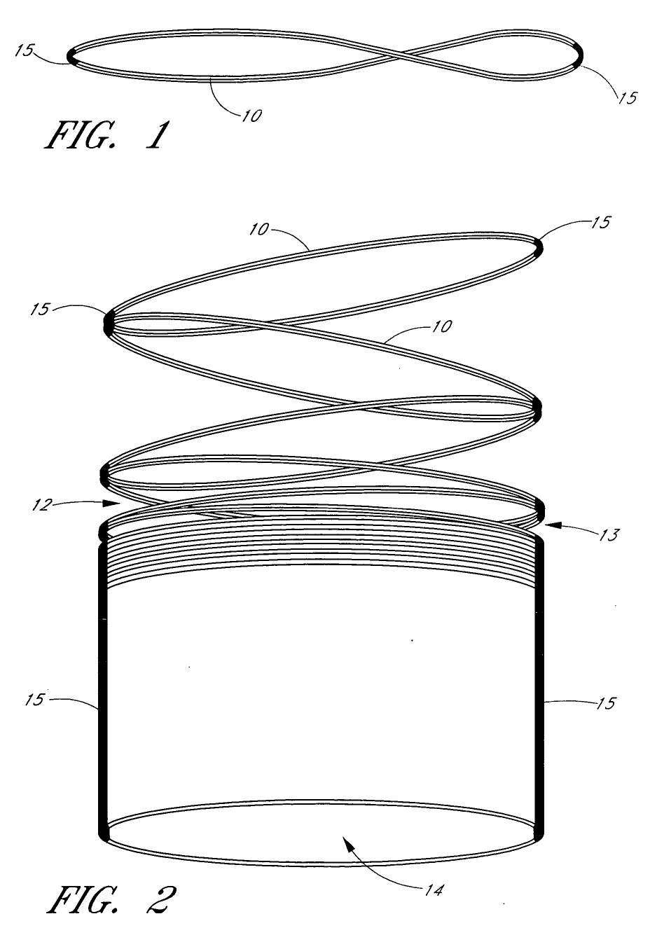

FIG. 1 is a diagram depicting a side view of one embodiment of a continuous dental floss loop 10. As used herein, a “continuous loop” is a loop that is unbroken. As described above, a user may insert one or more fingers at two opposing points in the loop and pull the loop taut to provide a suitable tension in the loop for flossing between teeth and in the gingival sulcus without breaking the continuous loop 10. In various embodiments, the continuous loop 10 may be formed from a monofilament material, such as a polytetrafluoroethylene (PTFE) material, that is not formed from a plurality of woven or twisted fibers, and that provides a loop of sufficient strength to withstand pressure applied by a user during flossing without breaking.

In a preferred embodiment, the loop 10 has a diameter of approximately four to seven inches, and more preferably, five and one-half to six inches. In one embodiment, loops 10 of two or more sizes may be manufactured to suit the preferences of different users. For example, a small children's size loop of four to five inches diameter may be produced.

In a preferred embodiment, the floss is made of polytetrafluoroethylene (PTFE) or expanded PFTE (ePTFE), which are materials suited to glide smoothly within a narrow space between two adjacent teeth. PFTE and ePTFE provide additional advantages in terms of reduced incidence of shredding, breaking and/or fraying as compared to traditional nylon floss or other flosses formed from multiple polyamide fibers. Furthermore, dental floss made of PTFE or ePTFE provides a filament with little stretch, thus making it easier for the user to apply sufficient tension to a section of floss to allow the floss to slide between adjacent teeth. Furthermore, ePTFE provides a surface that is comfortable to grip and that is sufficiently rough inside the mouth to effectively clean teeth. The properties, manufacture, and use of ePTFE for dental floss are described in U.S. Pat. No. 5,518,012 to Dolan et al., entitled EXPANDED PTFE FLOSS MATERIAL AND METHOD OF MAKING SAME, issued May 21, 1996, the entirety of which is incorporated herein by reference. As described in the aforementioned patent, ePTFE may change slightly in appearance when compressed and may thus provide a visual indication to the user as to which sections of the floss loop 10 have been used so that the user may more accurately reposition the loop to floss a next section of teeth with an unused portion of the floss loop 10.

In other embodiments, non-expanded or other polytetrafluoroethylene (PTFE) may advantageously be used to form the dental floss loop 10. The properties, manufacture, and use of PTFE for dental floss are described in the following five U.S. patents and two U.S. patent application publications, the entireties of which are incorporated herein by reference: U.S. Pat. No. 5,989,709 to Kelmartin, et al., issued Nov. 23, 1999 and entitled POLYTETRAFLUOROETHYLENE FIBER; U.S. Pat. No. 6,071,452 to Kelmartin, et al., entitled PROCESS OF MAKING POLYTETRAFLUOROETHYLENE FIBER and issued Jun. 6, 2000; U.S. Pat. No. 6,114,035 to Kelmartin, et al., issued Sep. 5, 2000 and entitled POLYTETRAFLUOROETHYLENE FIBER; U.S. Pat. No. 6,117,547 to Kelmartin, et al., entitled POLYTETRAFLUOROETHYLENE FIBER and issued Sep. 12, 2000; U.S. Pat. No. 6,539,951 to Baillie, et al., issued Apr. 1, 2003 and entitled DENTAL FLOSS HAVING A LOW DENSITY AND METHOD OF MAKING SAME; U.S. patent application Publication No. 2003/172,951 to Baillie, et al., published Sep. 18, 2003 and entitled DENTAL FLOSS HAVING A LOW DENSITY AND METHOD OF MAKING SAME; and U.S. patent application Publication No. 2003/196,676 to Baillie, et al., published Oct. 23, 2003 and entitled DENTAL FLOSS HAVING A LOW DENSITY AND METHOD OF MAKING SAME.

U.S. Pat. No. 5,518,012, cited above, discloses a method of making ePTFE material as a flat sheet that may be cut to form filaments for use as dental floss. By making the sheet of ePTFE material around a cylindrical shape, a cylindrical sleeve of ePTFE may be formed from which dental floss loops 10 may be cut, as described in greater detail with reference to FIGS. 2, 5, and 6 below. According to another method for making a cylindrical sleeve of ePTFE or other PTFE or monofilament material, a hole may be formed in a flat sheet of material, and the sheet with the hole in it may then be shaped and trimmed into a cylindrical shape, as will be familiar to one of ordinary skill in the art. Alternatively, other methods for forming a cylindrical sleeve 14, which may, for example, involve techniques of extruding or spinning, may be used.

FIG. 2 is a diagram depicting one embodiment of a method for cutting a sleeve of ePTFE, or other PTFE or monofilament material, to create a chain of continuous dental floss loops 10. According to the embodiment depicted in FIG. 2, PTFE or ePTFE is formed as a cylindrical sleeve 14 of material. Diametrical cuts 12, 13 may then be made across portions of the cylindrical sleeve 14. According to some embodiments, the cylindrical sleeve 14 of material may be flattened by rolling or pressing with a flat press in order to facilitate cutting. According to one embodiment, a stationary or semi-stationary cutter comprising one or more blades with limited up and down movement may be used for cutting the material. A bed for holding the material for cutting may be cammed so that it advances the material slightly for each new cut or set of cuts. Alternatively, a cutting mechanism may be used that comprises multiple cutting blades situated in channeled wood or metal, so that when the material is positioned on a flat surface of wood or nylon, a press comes together and forces the blades through the material, effectively performing multiple cuts with a single motion. These or other methods for cutting thin sleeves of material may be used to produce the continuous loops 10.

Although, for simplicity of drawing, two adjacent cuts 12, 13 are referenced by number in FIG. 2, it is to be understood that similar parallel, alternating, diametrical cuts are made along the length of the cylindrical sleeve 14. As depicted in FIG. 2, adjacent cuts 12, 13 begin at opposing points around the circumference of the cylindrical sleeve 14 and end a small distance before reaching an opposite edge of the cylindrical sleeve. Thus, the cuts 12, 13 do not detach the cylindrical sleeve 14 into separate pieces. Instead, the alternating cuts 12, 13 along the length of the cylindrical sleeve 14 form from the cylindrical sleeve 14 a string or chain of loops 10 that are attached by small sections of uncut material

In a preferred embodiment of a method for creating a chain of continuous dental floss loops 10, two longitudinal stripes of the material at opposing points around the circumference of the cylindrical sleeve 14 are colored in a color that contrasts with the remainder of the cylindrical sleeve 14. For example, if the cylindrical sleeve 14 is white or near-white, the stripes may be red, blue, green, or black.

In embodiments where the two colored stripes 15 extend longitudinally along opposing points around the circumference of the cylindrical sleeve 14, adjacent cuts 12, 13 may begin at alternating stripes 15 and may extend diametrically across the cylindrical sleeve 14 up to the opposing stripe 15. Thus, the small sections of uncut material between the loops 10 may be positioned to include the colored material of the stripes 15, and the colored material 15 may serve as a visual indicator to mark a joined section between two adjacent loops 10.

FIG. 3 is a diagram depicting one embodiment of a bobbin reel 18 wound with a chain of continuous dental floss loops 10 ready for dispensing. When the cylindrical sleeve 14 is cut along its length as described with reference to FIG. 2, the material may be extended to form a chain or string of attached loops 10 that may be wound like a string around the bobbin reel 18. FIG. 3 depicts one such string of loops 10 wound around the bobbin reel 18, with an end of one loop 10, marked with the colored portion of a stripe, visible as it is drawn off the bobbin reel 18.

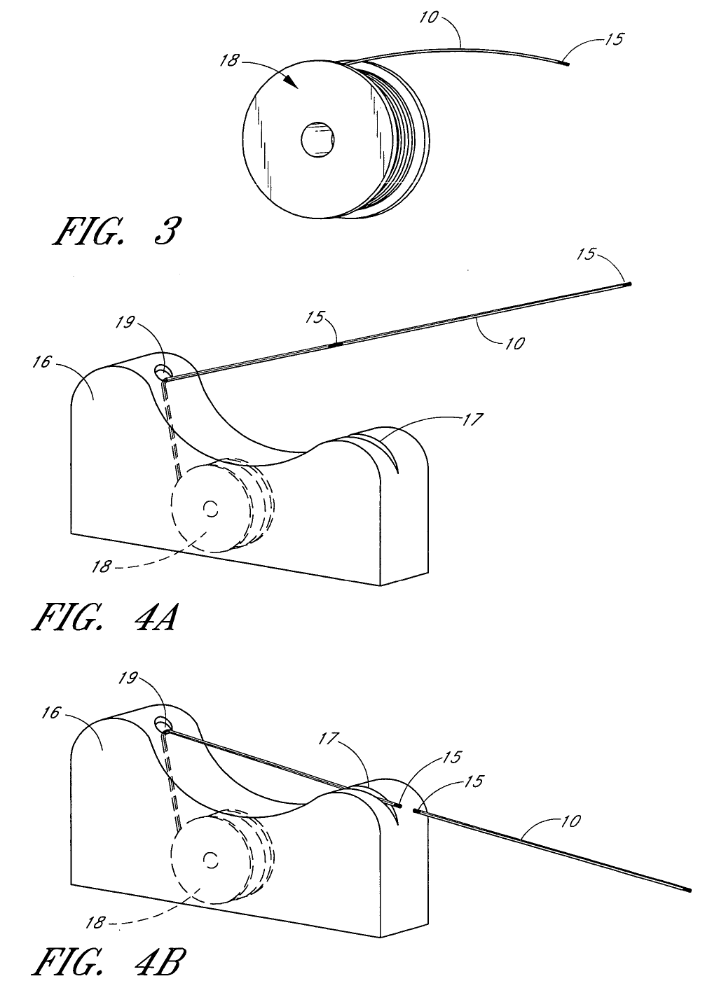

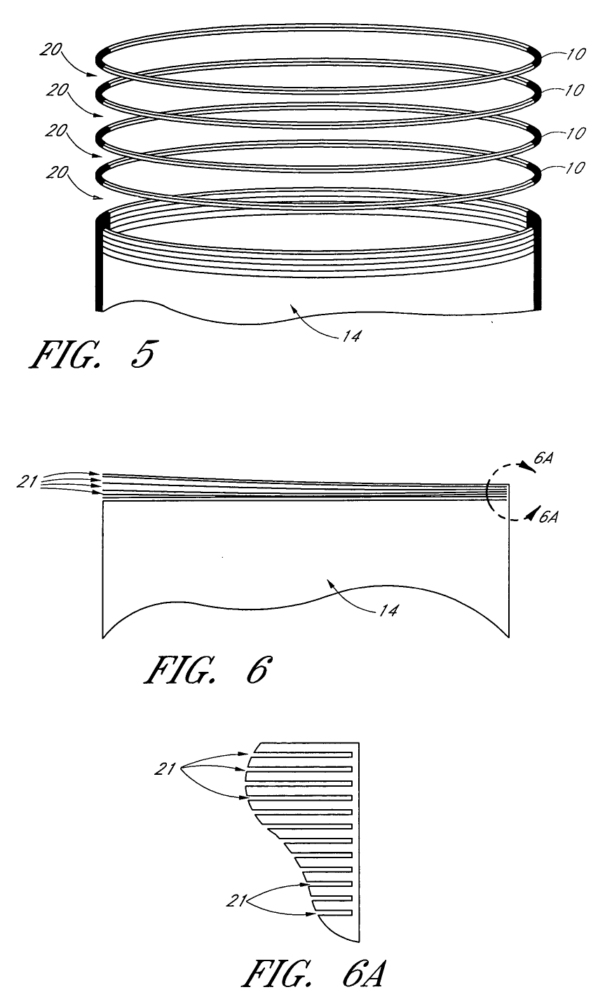

FIG. 4A is a diagram depicting a cutaway view of a first embodiment of a dispenser 16 for a chain of continuous dental floss loops 10. As depicted in FIG. 4A, the dispenser 16 is formed of a plastic material as will be familiar to one of ordinary skill in the art. The dispenser 16 is shaped as a hollow or near-hollow body with space provided inside for a bobbin reel 18, as described with reference to FIG. 3, wound with a chain of continuous floss loops 10. The bobbin reel 18 is situated within the dispenser 16 in a manner that allows the bobbin reel 18 to rotate as the chain of floss loops 10 is drawn off the bobbin reel 18.

As depicted in FIG. 4A, the dispenser further comprises a hole 19 in the body of the dispenser 16 and a set of gripping fingers 17. The hole 19 in the body of the dispenser 16 allows the chain of floss loops 10 to be drawn off the bobbin reel 18 inside the dispenser 16, through the hole 19, and towards the set of gripping fingers 17.

FIG. 4B is a diagram depicting one embodiment of a method for separating a continuous dental floss loop 10 from the dispenser 16. As described with reference to FIG. 4A, the chain of floss loops is drawn from the bobbin reel 18, through the hole 19, and towards the gripping fingers 17. The chain of floss loops is drawn by a user through a narrow opening between the gripping fingers 17, and the gripping fingers 17 secure the chain of floss loops with friction as placed by the user. Once the chain of floss loops is held in place by the gripping fingers 17, the user may break off an end portion of the chain of loops 10 that extends beyond the gripping fingers 17.

The user may use the colored loop end markers 15 to accurately position the chain of floss loops so that a connecting portion between adjacent loops 10 is positioned adjacent to the gripping fingers 17. Thus, the chain of loops may be torn off at an uncut section 15 between adjacent loops, allowing a continuous loop 10 to be torn off of the chain while remaining intact as a continuous loop 10. Properties of the ePTFE material, as disclosed in U.S. Pat. No. 5,518,012 and in U.S. patent application Publication No. 2003/0196676, allow a loop 10 to be torn off using the dispenser 16, while still retaining sufficient tensile strength to allow the user to apply tension to the loop 10 for flossing, as described with reference to FIG. 1.

FIG. 5 is a diagram depicting continuous dental floss loops 10, stacked for packaging or use, that are produced by an embodiment of a second method for cutting a sleeve 14 of PTFE or ePTFE. According to the method associated with the loops 10 depicted in FIG. 5, diametrical cuts 20 are made across the cylindrical sleeve 14 to form the loops 10. In contrast to the cuts 12, 13 depicted in FIG. 2, the cuts 20 associated with the loops 10 depicted in FIG. 5 extend across the full width of the cylindrical sleeve 14. Thus, individual, separated loops 10 are detached from the cylindrical sleeve 14 without being formed into a chain of loops 10. Loops 10 formed according to an embodiment of this method may be packaged, for example, in a plastic bag from which a user may pull out individual loops for flossing use. Furthermore, the cylindrical sleeve 14 from which the loops 10 are cut according to an embodiment of this method may be formed without inclusion of colored stripes 15.

FIG. 6 is a diagram depicting an embodiment of a third method for cutting a cylindrical sleeve 14 of PTFE or ePTFE to create continuous dental floss loops 10. According to the method depicted in FIG. 6, diametrical cuts 21 are made across the width of the cylindrical sleeve 14. In contrast to the cuts 12, 13 depicted in FIG. 2, the cuts 21 of FIG. 6 begin on one side of the cylindrical sleeve 14 and extend for a distance just slightly less than the diameter of the cylindrical sleeve 14. Thus, a small portion of the cylindrical sleeve 14 remains attached for each cut 21 along a single side of the cylindrical sleeve 14, as is shown in greater detail in FIG. 6A. Embodiments of this method produce loops 10 that are connected to one another along one side but that do not form a chain of loops. Such loops 10 may be torn off from one another while retaining their continuous loop shape with the tensile strength to allow for effective flossing.

Embodiments of systems and methods for manufacturing and dispensing continuous monofilament loops of dental floss have been described. Although this invention has been described in terms of certain preferred embodiments, other embodiments that are apparent to those of ordinary skill in the art are also within the scope of this invention. Accordingly, the scope of the present invention is intended to be defined only by reference to the appended claims.

In the claims, which follow, reference characters used to denote process steps are provided for convenience of description only, and not to imply a particular order for performing the steps.

1. A method of forming dental floss, comprising:
forming a polytetrafluoroethylene (PTFE) material into a continuous loop.

2. A method as defined in claim 1, wherein said forming step comprises forming said continuous loop from expanded polytetrafluoroethylene (ePTFE).

3. A method as defined in claim 1, wherein said forming step comprises:
forming a continuous sleeve of said PTFE material; and
making a first cut across said sleeve.

4. A method as defined in claim 3, wherein said step of making a first cut across said sleeve comprises cutting across said sleeve without completely cutting through an entire circumference of said sleeve.

5. A method as defined in claim 3, wherein said step of making a first cut across said sleeve results in a small section of said circumference remaining uncut.

6. A method as defined in claim 3 additionally comprising:
making a second cut across said sleeve.

7. A method as defined in claim 6, wherein said step of making a first cut across said sleeve comprises cutting across an entire circumference of said sleeve, and wherein said step of making said second cut across said sleeve comprises cutting across an entire circumference of said sleeve.

8. A method as defined in claim 7, wherein said step of making a first cut across said sleeve and said step of making a second cut across said sleeve result in the formation of a detached continuous loop of PTFE material.

9. A method as defined in claim 6, wherein said step of making a second cut across said sleeve comprises making said second cut parallel to said first cut to form a first strip of material.

10. A method as defined in claim 9, wherein said step of making a second cut across said sleeve comprises cutting said sleeve without cutting completely through the entire circumference of said sleeve.

11. A method as defined in claim 9, wherein said step of making a second cut across said sleeve comprises cutting through a different circumferential portion of said sleeve than that which was cut in making said first cut across said sleeve.

12. A method of forming a chain of detachably connected continuous dental floss loops, said method comprising:
(a) forming a cylindrical sleeve of a polytetrafluoroethylene (PTFE) material;
(b) making a first cut across said cylindrical sleeve along a diametrical axis without completely cutting through an entire circumference of said cylindrical sleeve, such that a first small section of said circumference along a first longitudinal strip remains uncut;
(c) making a second cut across said cylindrical sleeve adjacent and parallel to said first cut without completely cutting through an entire circumference of said cylindrical sleeve, such that a second small section of said circumference along a second longitudinal strip remains uncut, wherein said second longitudinal strip is diametrically opposed to said first longitudinal strip; and
(d) repeating steps (b) and (c) until a chain of detachably connected continuous dental floss loops of desired length is formed.

13. The method of claim 12, wherein elements (a), (b), (c), and (d) are carried out in the order presented.

14. The method of claim 12, wherein elements (b), (c), and (d) are carried out substantially simultaneously.

15. The method of claim 12, further comprising causing said first longitudinal strip and said second longitudinal strip to be colored.

16. The method of claim 12, wherein said cylindrical sleeve has a diameter of between four and seven inches.

17. The method of claim 16, wherein said cylindrical sleeve has a diameter of between four and one-half inches and six inches.

18. The method of claim 12, wherein said first and second cuts are approximately 0.5 to 3.0 mm apart.

19. An uninterrupted loop of material formed of identical material throughout the loop.

20. The continuous loop of dental floss of claim 19, wherein said identical material is a polytetrafluoroethylene (PTFE) material.

21. The continuous loop of dental floss of claim 20, wherein said PTFE material is an expanded polytetrafluoroethylene (ePTFE) material.

22. An uninterrupted loop of dental floss material having an identical cross-section throughout the loop.

23. A dispenser for dispensing continuous dental floss loops, comprising:
a bobbin with a chain of continuous monofilament dental floss loops wound around it; and
a container configured to house said bobbin such that said bobbin is free to rotate about an axis, allowing a portion of said chain of continuous dental floss loops to unwind from said bobbin, said container comprising a gripping mechanism configured to secure with friction, at a location near one end of one of said two continuous dental floss loops, said portion of said chain of continuous dental floss loops, said gripping mechanism securing said portion of said chain of continuous dental floss loops with sufficient strength to allow at least one continuous dental floss loop to be torn off of said chain when sufficient pressure is applied to said continuous loop.

24. The dispenser of claim 23, wherein said container further comprises a hole for allowing said portion of said chain of continuous dental floss loops that are unwound from said bobbin to pass through and for guiding said portion of said chain to said gripping mechanism.

25. The dispenser of claim 23, wherein said chain of continuous dental floss loops is colored at said sections between said continuous dental floss loops.
